(19) United States
(12) Patent Application Publication
(10) Pub. No.: US 2017/0258283 A1
(43) Pub. Date: Sep. 14, 2017

(54) Vacuum Attachment for Picking Up an Object

(71) Applicant: Mary P. Hardin, Chapel Hill, NC (US)

(72) Inventor: Mary P. Hardin, Chapel Hill, NC (US)

(21) Appl. No.: 15/453,541

(22) Filed: Mar. 8, 2017

Related U.S. Application Data
(60) Provisional application No. 62/305,607, filed on Mar. 9, 2016.

(51) Int. Cl. A47L 7/00; A47L 9/06; B65G 47/91

(52) U.S. Cl. CPC A47L 7/009; B65G 47/91; A47L 9/0693

(57) ABSTRACT

Provided is a vacuum attachment for picking up an object. The vacuum attachment in embodiments comprises a hollow body with open ends including an intake end as well as a vacuum-side end. The vacuum-side end is sized and configured to removably attach to an intake port of a vacuum source. A channel is formed within the hollow body and extends along a longitudinal axis of the hollow body from the vacuum-side end to the intake end. A filter is disposed within the channel, transverse to the longitudinal axis of the hollow body, and adjacent to, but offset from, the intake end of the hollow body so as to form a lip surrounding the filter. The filter is fixedly attached to an inner surface of the hollow body. In some embodiments, the filter is configured to pass solid particulates but to block objects larger than solid particulates.

### RELATED APPLICATIONS

This application claims priority to U.S. Provisional Patent Application Ser. No. 62/305,607, filed Mar. 9, 2016, the entire contents of which are incorporated herein by reference.

### TECHNICAL FIELD

This disclosure relates generally to an attachment for a vacuum source such as a vacuum cleaner, and more particularly to an attachment to pick-up objects.

### BACKGROUND

A conventional vacuum cleaner creates a partial vacuum (e.g., using an air pump) to clean surfaces. The vacuum cleaner applies suction to intake unwanted objects found on surfaces (e.g., dust and trash). The vacuum cleaners trap the unwanted objects for disposal. For example, one type of vacuum cleaner uses an internal bag to trap unwanted objects taken in by the vacuum cleaner for disposal in the bag. Additionally or alternatively, some vacuum cleaners have a cloth filter removably disposed between an intake end of the vacuum cleaner and the suction source, in order to collect small particulates that may be harmful to the vacuum cleaner and can be disposed of with the filter.

Some conventional vacuum cleaners have ports for attaching hoses and/or other attachments for special cleaning purposes. For example, U.S. Pat. No. 4,598,439 describes a magnetic-vacuum-cleaner attachment for removing metal objects for disposal.

### SUMMARY

Embodiments herein include a vacuum attachment for picking up an object, e.g., a wanted object not intended for disposal. The vacuum attachment comprises a hollow body, a channel formed within the hollow body and a filter disposed within the channel. The hollow body has open ends including an intake end as well as a vacuum-side end that is sized and configured to removably attach to an intake port of a vacuum source (e.g., a vacuum cleaner). The channel formed within the hollow body extends along a longitudinal axis of the hollow body from the vacuum-side end to the intake end. The filter disposed within the channel is transverse to the longitudinal axis of the hollow body and adjacent to, but offset from, the intake end of the hollow body so as to form a lip between the intake end and the filter. The filter is fixedly attached to an inner surface of the hollow body.

In some embodiments, the filter is configured to pass solid particulates but to block objects larger than solid particulates.

### BRIEF DESCRIPTION OF THE DRAWINGS

FIG. 1A depicts an attachment attached to a vacuum source picking up objects in one or more embodiments.

FIG. 1B depicts a filter disposed in an attachment for a vacuum source in one or more embodiments.

FIG. 2A depicts a side view of an attachment for a vacuum source in one or more embodiments.

FIG. 2B depicts an attachment for a vacuum source from an intake end in one or more embodiments.

FIG. 2C depicts a cross-sectional view of an attachment for a vacuum source in one or more embodiments.

FIG. 3A depicts a side view of an attachment for a vacuum source in one or more embodiments.

FIG. 3B depicts an attachment for a vacuum source from an intake end in one or more embodiments.

FIG. 4A depicts a side view of an attachment for a vacuum source in one or more embodiments.

FIG. 4B depicts an attachment for a vacuum source from an intake end in one or more embodiments.

FIG. 5 depicts a side view of an attachment with multiple filters for a vacuum source in one or more embodiments.

### DETAILED DESCRIPTION

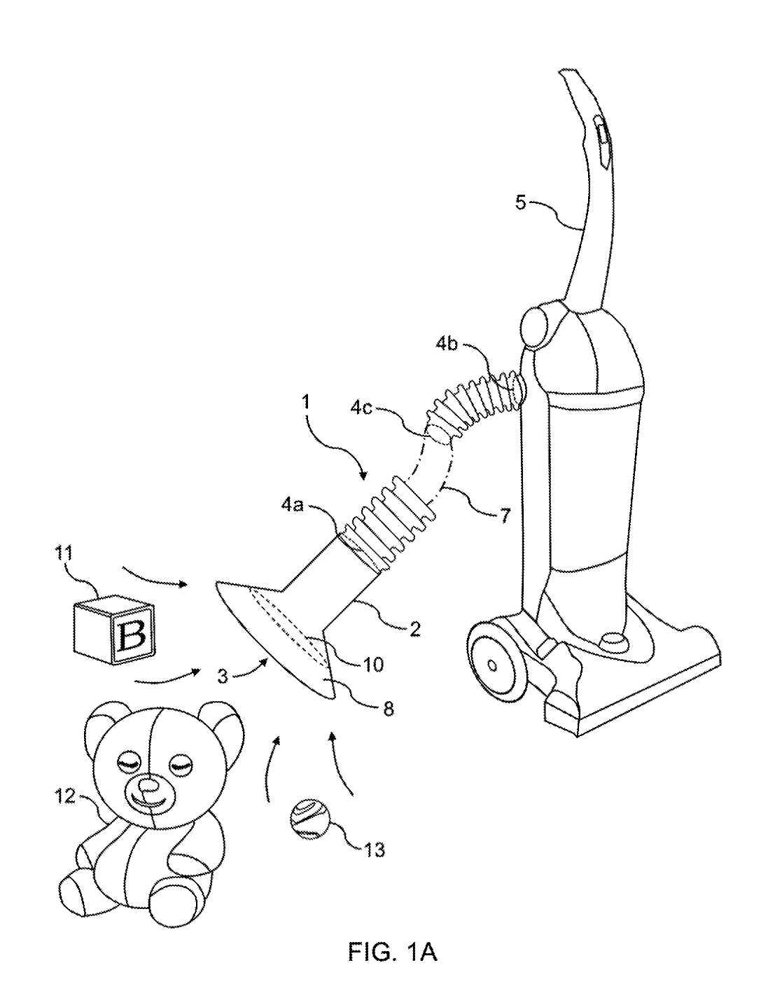

The FIGS. 1A-B show an attachment 1 for a vacuum source 5 (e.g., a conventional vacuum cleaner). The attachment 1 has a hollow body 2 with an open, intake end 3 for picking up an object, e.g., wanted objects 11, 12 and 13 not intended for disposal. The object could be, for example, in a place difficult to reach and directly pick-up (e.g., behind a sofa or on a high shelf). Or the object could be part of a collection of objects that is inconvenient to reach down and individually pick-up (e.g., where there are numerous objects like a marble 13 and block 11). The attachment 1 in this regard exploits a vacuum source's suction force to pick-up the object.

More particularly, the attachment 1 has an open, vacuum-side end 4a, 4b, or 4c configured to removably attach to an intake port of a vacuum source 5. FIG. 1 A in this regard shows that in some embodiments the attachment 1 has a vacuum-side end 4a which attaches to an intake port formed at the end of a hose 7 associated with the vacuum source 5. FIG. 1A shows that in alternative embodiments the attachment 1 has a vacuum-side end 4b which attaches to an intake port formed in the body of the vacuum source 5. In these latter embodiments, therefore, the hose 7 may itself form part of the attachment's body 2. In still other embodiments the vacuum-side end attaches to an intake port formed at an intermediate point 4c in the hose 7.

Regardless, the attachment 1 comprises a channel 9 formed within the hollow body 2. The channel 9 extends along a longitudinal axis L of the hollow body 2, from the vacuum-side end 4 to the intake end 3. When the vacuum source creates a partial vacuum at its associated intake port, this creates suction in the channel 9 to pick-up one or more objects of various size and weights. As shown, a wanted object could be larger than the intake end 3 of the attachment 1 (e.g., teddy bear 12), smaller than the intake end 3 (e.g., marble 13) or roughly of similar size as the intake end 3 (e.g., block 11)

Regardless, a filter 10 is disposed within the channel 9. The filter 10 may comprise a grating, e.g., sized to pass solid particulates (e.g., dust or dirt) but to block objects larger than a defined wanted object size. The filter 10 may be disposed transverse (e.g., perpendicular) to the longitudinal axis L of the hollow body 2. The filter 10 in some embodiments is adjacent to, but offset from, the intake end 3 of the hollow body 2. With the filter so configured, the wanted object is sucked up by the attachment 1 but remains readily retrievable at or near the attachment's intake end 3. That is, not only does the filter 10 prevent the wanted object from entering the vacuum source 5, the filter 10 is positioned and otherwise configured to prevent the wanted object from entering the attachment's channel 9 to an extent that would make retrieval of the wanted object difficult.

In some embodiments, the filter 10 is offset from the intake end 3 so as to form a lip 8, e.g., between the filter 10 and the intake end 3. The lip 8 in some embodiments has one or more advantages. For example, the lip in embodiments is used to prevent an object from moving off the filter 10, to the side of the attachment 1 where it would lose suction and thus could not be picked up. In the same or different embodiments, the lip 8 is used to cradle and scoop up the object or rake the object closer to the vacuum source 5 for maneuvering the object to receive more direct suction power. In the same or different embodiments, the lip 8 has a rounded edge.

Alternatively or additionally, the hollow body 2 has an outer surface 2a and an inner surface 2b, and the filter 10 is fixedly attached to the inner surface 2b. For example, the filter 10 may be glued, nailed, screwed, welded, integrally formed with, or otherwise mechanically joined or affixed to the body's inner surface 2b. In at least some embodiments, this advantageously prevents the filter 10 itself from being sucked up into the vacuum source 5 or from falling out of the attachment 1 when the vacuum source 5 is turned off.

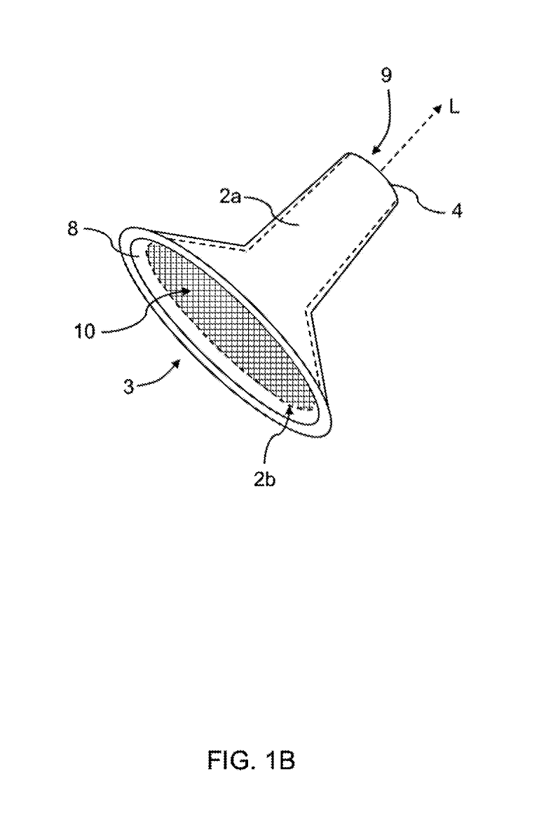

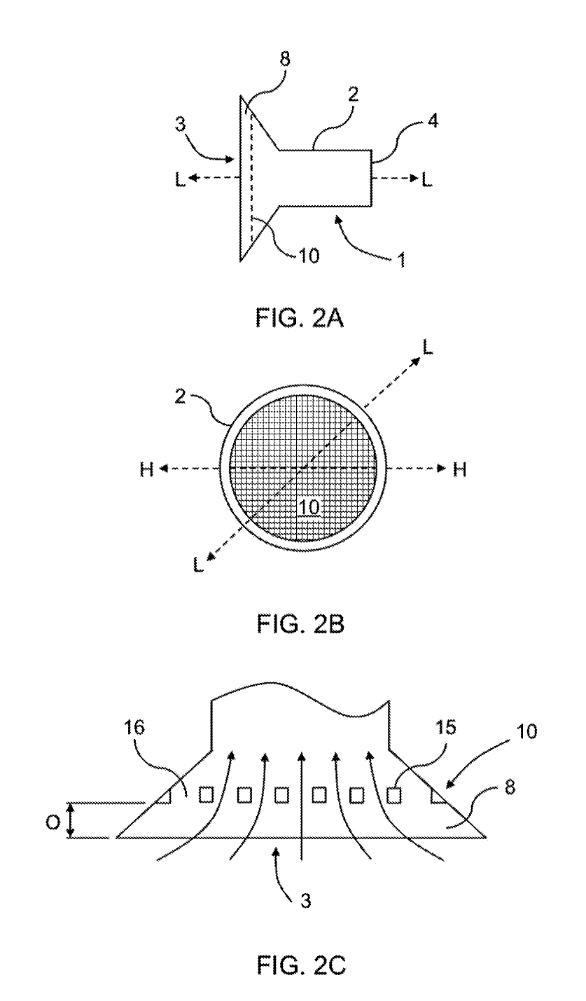

FIG. 2A, 2B, and 2C show an example attachment 1 from various angles. FIG. 2A shows a side view of the attachment 1. As shown in FIG. 3A in some embodiments the hollow body 2 of the attachment 1 is cylindrical. Other embodiments could have other shapes such as a rectangular prism shape. The filter 10 is integrated within the attachment 1 and not visible from the side view.

FIG. 3B shows the attachment 1 from the perspective of the intake end 3. In embodiments were the hollow body is cylindrical, the filter 10 is also cylindrical, so that the sides are at least partially in contact with the hollow body 2. In some embodiments, the filter 10 is removably attached and in other embodiments the filter is integrated permanently within the hollow body. If the filter is removably attached, this allows for switching out the filter 10 with various designs for various purposes, e.g., to pick up objects with different sizes and/or weights.

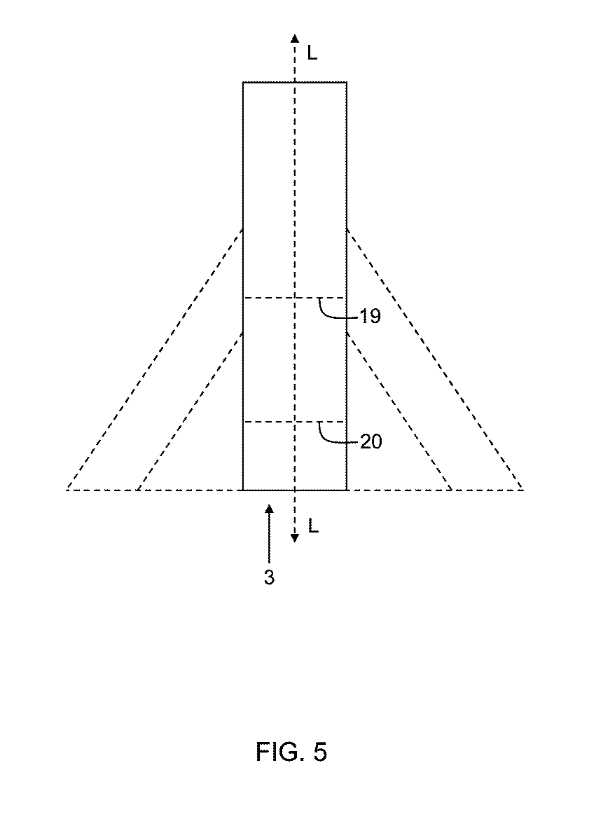

Alternatively or additionally, multiple filters may be included as shown for example in FIG. 5, with at least one filter being fixedly attached and another filter being removably attached. In this case, the fixedly attached filter 19 may be disposed inward of the removably attached filter 20 from the perspective of the intake end 3, e.g., such that the fixedly attached filter keeps the removably attached filter from being suctioned up during operation. Regardless, the filter 10 in one or more embodiments has different designs. For example the filter 10 in some embodiments has a design with a perforated surface. The filter 10 in some embodiments has a design that is a grate. The grate, as shown in FIG. 2B, in some embodiments has a grid pattern with a framework of spaced bars that are parallel to or cross each other. The spaces left in between the bars in some embodiments leave space to pass air and solid particulates but to block objects larger than solid particulates. In other embodiments, the space left only allows very fine particles to pass through the filter 10.

FIG. 2C shows the attachment 1 from a cross-sectional view, e.g., taken along cut H in FIG. 2B. The filter 10 is shown with holes 16 for allowing the suction to permeate the filter 10 to move the object against the filter 10. The filter 10 also has solid pieces 15 for preventing the object from moving past the filter, deeper into the channel of the attachment 1. The filter 10 is offset 0 from the intake end 3 of the attachment 1.

The lip 8 could have different shapes and sizes for different purposes. For example, the lip 8 in embodiments only partially surrounds the filter 10 to provide for example a scoop or an edge for trapping the object. This shape may provide greater advantages in moving an object sideways along a surface. In preferred embodiments, the lip 8 surrounds the entire filter to maximize surface area for cradling the object or raking the object.

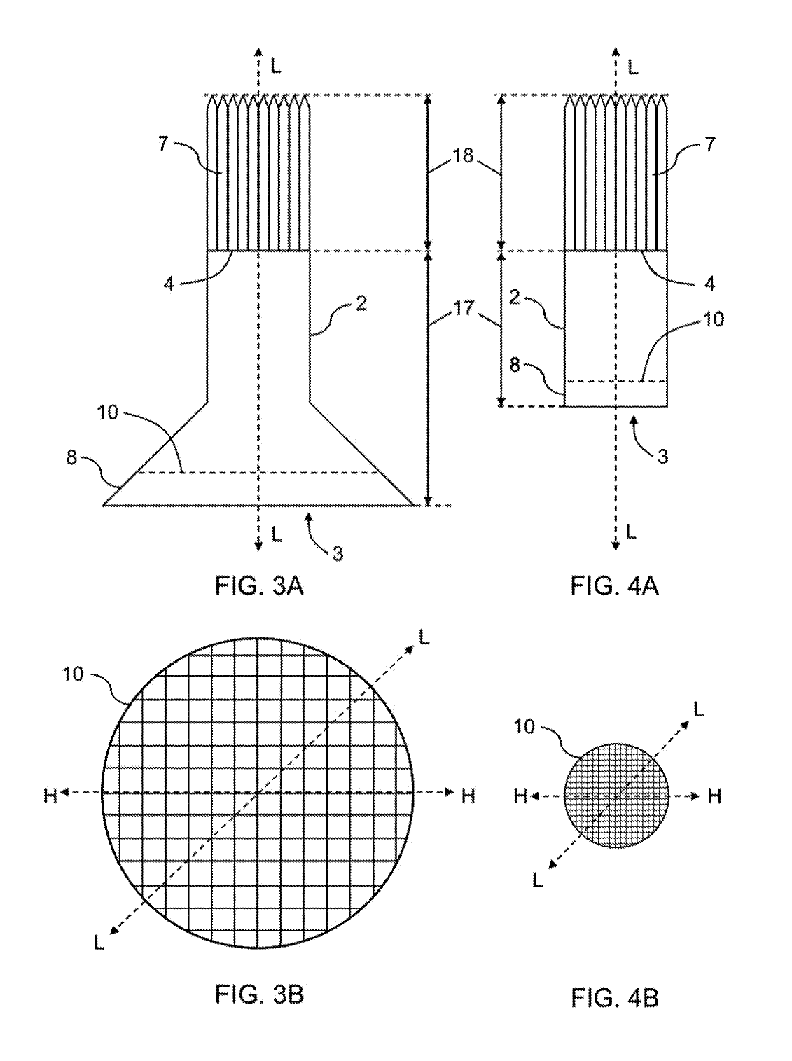

FIGS. 3A-3B, 4A-4B and 5 provide example embodiments of various lip configurations. As shown in FIG. 3A, the lip 8 could give the attachment 1 a conical or fluted shape, which may have concave or convex sides. For example, the portion of the channel adjacent to the intake end gradually increases in diameter in a direction towards the intake end 3. The filter could be placed within the area that is gradually increasing as shown in FIG. 3A or further back in the portion of the channel that is not increasing. Alternatively, the lip 8 could have a uniform diameter above and below the filter as shown in FIG. 4A and FIG. 5. This design may have manufacturing advantages in that it may be easier to produce an attachment with a uniform shape, rather than the conical or fluted shape shown in other figures. FIG. 5 also shows, for example, an optional intake end 3 that begins increasing in diameter at a point between the filters 20 and 19 or at a point above the filter 19.

FIG. 3B and FIG. 4B show an example filter 10 for FIG. 3A and FIG. 4A respectively. Depending on the size of the hollow body 2 and the placement within the hollow body 2, the filter 10 could be of various sizes as shown. Also, the filter 10 could have a grid pattern with more (e.g., FIG. 3B) or less space (e.g. FIG. 4B) between crossbars to allow for larger or smaller objects to pass through.

As shown in FIGS. 3A and 4A, the attachment 1 could be comprised of various materials of flexible and/or rigid materials. For example, a first portion 17 of the attachment 1 could be made of plastic or other hard surface and a second portion 18 could be made of a flexible elasticized material such as rubber. This second portion 18 of the attachment could be used to enable more flexibility in attaching to ports of various shapes and sizes but a rigid connection could be used for a particular portion. The flexible material could also provide advantages in moving the attachment along non-linear paths such as bending the attachment under a sofa to reach an object. The flexible and/or rigid materials could enable the attachment to extend the channel such as using a telescope structure. Regardless of the materials used at the vacuum-side end 4, the attachment is configured to attach to an intake port of a vacuum source 5. The attachment creates a seal between the attachment and the intake port. For example, the attachment could screw onto the port or could be stretched to fit snuggly around the port.

The attachment in some embodiments is configured to attach to an intake port of a particular type of vacuum source, such as a vacuum cleaner. In other embodiments, the attachment is configured to interchangeably attach to an intake port of any one of multiple different types of vacuum sources. A vacuum source in this regard includes any type of source that creates a partial vacuum or suction force. Vacuum sources thereby include for instance apparatuses with an air or vacuum pump for creating a partial vacuum or suction. This partial vacuum may be created through any manual, mechanical, or electrical means for creating pressure differences (e.g., a centrifugal pump). For example, the partial vacuum may be created through movement of water rather than movement of air (e.g., a water pump). Alternatively, the partial vacuum may be created through manual movement of a suction cup (e.g., similar to a toilet bowl plunger).

What is claimed is:

1. A vacuum attachment for picking up an object, the vacuum attachment comprising:
a hollow body with open ends including an intake end as well as a vacuum-side end, the vacuum-side end is sized and configured to removably attach to an intake port of a vacuum source;
a channel formed within the hollow body and extending along a longitudinal axis of the hollow body from the vacuum-side end to the intake end; and
a filter disposed within the channel, transverse to the longitudinal axis of the hollow body, and adjacent to, but offset from, the intake end of the hollow body so as to form a lip surrounding the filter, wherein the filter is fixedly attached to an inner surface of the hollow body.

2. The vacuum attachment of claim 1, wherein the vacuum source is a vacuum cleaner.

3. The vacuum attachment of claim 1, wherein the filter comprises a grating.

4. The vacuum attachment of claim 1, wherein the filter is configured to pass solid particulates but to block objects larger than solid particulates.

5. The vacuum attachment of claim 1, wherein the hollow body is cylindrical.

6. The vacuum attachment of claim 1, wherein a portion of the channel adjacent to the intake end gradually increases in diameter in a direction towards the intake end.

7. The vacuum attachment of claim 1, wherein the lip has a depth in the direction along the longitudinal axis of the hollow body that is between half an inch and 2 inches.

8. A vacuum attachment for picking up an object, the vacuum attachment comprising:
a cylindrical body that is hollow and that has a conical end opposite a vacuum-side end; and
a grating fixedly attached within the cylindrical body at a point that is adjacent to, but offset from, an edge of the conical end.

9. The vacuum attachment of claim 8, wherein the grating is offset from the edge of the conical end by a distance between half an inch and two inches.

10. The vacuum attachment of claim 8, further comprising a lip formed at the edge of the conical end.

11. The vacuum attachment of claim 10, wherein the lip has a depth in the direction along a longitudinal axis of the cylindrical body that is between half an inch and two inches.

12. The vacuum attachment of claim 8, wherein the grating has holes with a diameter between a quarter of an inch and one inch.

13. The vacuum attachment of claim 8, wherein the grating has holes with a diameter between one inch and two inches.

14. The method of claim 8, wherein the vacuum-side end is sized and configured to removably attach to an intake port of a vacuum source.

15. A vacuum attachment for picking up an object, the vacuum attachment comprising:
a filter configured to be removably attached to an inner surface of a hollow body,
wherein the filter is configured to removably attach offset from an intake end of the hollow body, and perpendicular to a longitudinal axis that extends from the intake end to a vacuum-side end of the hollow body, the vacuum-side end for attaching to an intake port of a vacuum source; and
wherein when the filter is attached to the inner surface of the hollow body it forms a lip surrounding the filter on the intake side of the hollow body.

16. The vacuum attachment of claim 15, wherein the filter is a grating.

17. The vacuum attachment of claim 15, wherein the filter is configured to pass solid particulates but to block objects larger than solid particulates.

18. The vacuum attachment of claim 15, wherein the vacuum attachment comprises the hollow body.

19. The vacuum attachment of claim 18, wherein the vacuum attachment comprises one or more additional filters, wherein each of the filters is configured to be either integrated into the inner surface of the hollow body or removably attached.

20. The vacuum attachment of claim 19, wherein the vacuum attachment comprises a filter integrated into the hollow body between the removably attached filter and the vacuum-side end of the hollow body.
